(19) United States
(12) Patent Application Publication
(10) Pub. No.: US 2011/0100224 A1
(43) Pub. Date: May 5, 2011

(54) COUNTER FLOW CONTACTOR WITH LIQUID CARRY-OVER REDUCTION ASSEMBLY

(76) Inventor: Sean D. Gabel, Blanchard, OK (US)

(21) Appl. No.: 12/768,048

(22) Filed: Apr. 27, 2010

Related U.S. Application Data
(60) Provisional application No. 61/173,033, filed on Apr. 27, 2009.

(51) Int. Cl. B01D 47/00

(52) U.S. Cl. 96/262

(57) ABSTRACT

A counter flow contactor which includes a vessel with at least one bubble tray assembly positioned therein. A liquid carry-over reduction assembly is positioned in the vessel and includes a plate extending across the vessel and a tubular member extending upwardly from the plate in such a way that the tubular member provides a fluid passage from a lower side of the plate to an upper side of the plate. The tubular member cooperating with the vessel to define a liquid receiving space. The liquid carry-over reduction assembly further having a deflector plate spaced from the upper end of the tubular member in such a way that liquid passing up through the tubular member is deflected into the liquid receiving space while gas is allowed to pass to the gas outlet of the vessel, and a liquid return line extending downwardly from the plate in alignment with the other aperture of the plate.

### CROSS REFERENCE TO RELATED APPLICATIONS

This application claims benefit of provisional application U.S. Ser. No. 61/173,033, filed Apr. 27, 2009, which is hereby expressly incorporated herein by reference in its entirety.

### BACKGROUND OF THE INVENTION

1. Field of the Invention

The inventive concepts disclosed and claimed herein relate generally to a gas dehydrating apparatus, and more particularly, but not by way of limitation, to a device for reducing liquid carry-over in a counter flow contactor.

2. Brief Description of Related Art

A number of systems exist for removing water and other liquids from natural gas. Most of these dehydration systems involve passing the natural gas through or in contact with one of a number of known desiccant fluids, such as glycol. For brevity, the desiccant fluid may hereinafter be referred to as glycol, but it should be understood that glycol is only one exemplary desiccant fluid that may be used with such a system. The glycol essentially absorbs the water and other liquids from the natural gas, after which, natural gas is removed from the dehydration system to be sold, or otherwise used, and the “rich” glycol is cycled through the system to be regenerated or returned to a “lean” state in which it can be reused to dehydrate more natural gas.

The gas and the glycol are passed through an apparatus in a counter flow arrangement. The apparatus is commonly known as a contactor or an absorber. The contactor is in the form of an upright vessel having a gas inlet near the bottom and a gas outlet at the top. The vessel further has a desiccant inlet near the top and a desiccant outlet near the bottom. Within the vessel are a number of vertically spaced tray assemblies that include bubble caps. The concentrated or “lean” glycol is continuously pumped to the top tray of the contactor where it flows across the tray. The gas that enters the vessel via the inlet migrates upward into the bubble caps and passes out through slots in the bubble caps into contact with the glycol. As the glycol absorbs water from the gas, the glycol spills over the edge of a downcomer pipe and passes from the top tray to the next tray below where the process is repeated until the “rich” glycol reaches the bottom of the vessel and is discharged from the vessel and treated to remove the water from the glycol. In contrast, the gas passes upward through each tray bubbling through each successive level of glycol until it reaches the top of the tower where it passes through the gas outlet.

One problem encountered with the use of glycol contactors is glycol loss. Glycol losses are generally grouped into three categories—vaporization, carryover, and mechanical. The loss of glycol from carryover is generally due to foaming, high gas velocity or inadequate mist eliminator at gas outlet. With respect to high gas velocity, this is often experienced when there is a pressure surge with the gas entering the vessel. As a consequence of the surge, a portion of the glycol may be lifted up and out the vessel via the gas outlet.

To this end, a need exists for a device that is capable of retaining glycol that may be acted on by surges through the vessel. It is to such a device that the inventive concepts disclosed and claimed herein are directed.

### BRIEF DESCRIPTION OF THE DRAWINGS

FIG. 1 an elevational view of a prior art counter flow contactor.

FIG. 1A is a sectional view of the contactor of FIG. 1.

FIG. 2 is a sectional view of a portion of a counter flow contactor constructed in accordance with the inventive concepts disclosed and claimed herein.

FIG. 3 is a sectional view taken along line 3-3 of FIG. 2.

FIG. 4 is a sectional view of another embodiment of a counter flow contactor constructed in accordance with the inventive concepts disclosed and claimed herein

### DETAILED DESCRIPTION OF EXEMPLARY EMBODIMENTS

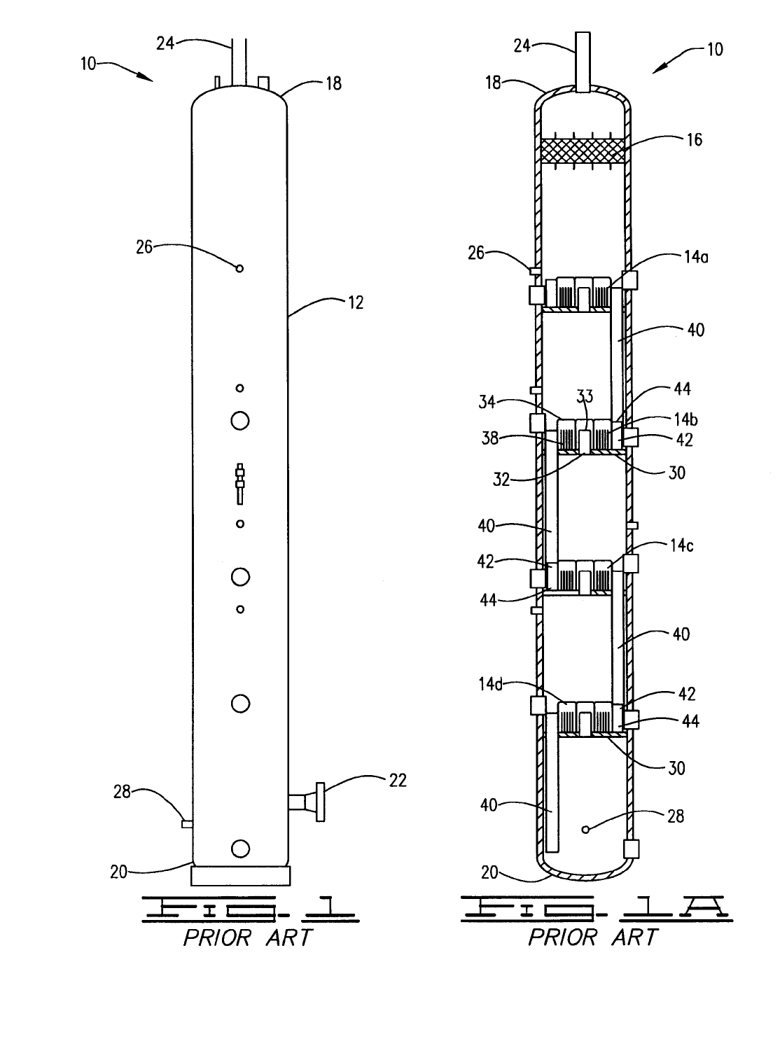

Referring now to the drawings, and in particular FIGS. 1 and 1A, shown is a prior art counter flow contactor 10 (also known as an absorber). The contactor 10 includes a vessel 12, a plurality of bubble tray assemblies 14, and a mist eliminator 16. The contactor 10 primarily functions to remove water from natural gas. The contactor 10 performs this function by bringing the natural gas into contact with a desiccant fluid which absorbs the water from the natural gas. Desiccant fluids typically used in the art include diethylene glycol, triethylene glycol, mixtures of diethylene and triethylene glycols, or diglycol amine. The desiccant fluid may be any other suitable fluid as well, and for simplicity will hereafter be referred to as glycol.

The vessel 12 is of a vertical cylindrical configuration having an upper end 18 and a lower end 20. The vessel 12 includes a gas inlet 22 at the lower end 20 and a gas outlet 24 at upper end 18. The vessel 12 further includes a glycol inlet 26 at the upper end 18 and a glycol outlet 28 at the lower end 20. It will be appreciated that the vessel 12 may be of any size or capacity which is generally a function of variables such as gas composition, temperature, pressure, and gas flow rate.

The interior of the vessel 12 is partitioned by the bubble tray assemblies 14. The contactor 10 illustrated in FIG. 1A is shown as having four bubble tray assemblies 14a through 14d. It will be appreciated, however, that the number of bubble tray assemblies 14 utilized may be varied depending on operational conditions. Each bubble tray assembly 14 is shown to include a deck 30 provided with a series of apertures 32 through which rising gas or vapors will pass. A tubular nozzle 33 extends upwardly from each aperture 32. A bubble cap 34 is positioned over each nozzle 33. It will be appreciated that the number of bubble caps 34 will vary depending on the size and capacity of the contactor 10. The bubble cap 34 includes an inverted dome-shaped member with an annular skirt having a plurality of slots 38 formed therein to provide a multiplicity of tangentially disposed passageways. The lower edge of each bubble cap 34 rests on the deck 30 and is held in position in any suitable fashion, such as a screw (not shown). It should be appreciated that while the bubble tray assembly 14 described herein for purposes of this disclosure, the inventive concept disclosed herein may be employed with bubble tray assemblies of a variety of forms.

The gas will enter the vessel 12 through the gas inlet 22 where it is typically deflected upwardly. The gas will rise upwardly through the apertures 32 of each successive bubble tray assembly 14 until the gas reaches the upper end 18 of the vessel 12 and is discharged through the gas outlet 24.

The glycol enters the vessel 12 through the glycol inlet 26 and is typically deflected downwardly onto the deck 30 of the top bubble tray assembly 14 where the glycol will flow across the deck 30 and around the bubble caps 34. After the glycol reaches a pre-selected depth, the glycol will flow into a downcomer 40 where the glycol will travel down to a compartment 42 which is formed by the deck 30 and a weir 44. The bottom of the downcomer 40 is positioned below the top of the weir 44 to form a liquid seal. Once the glycol rises to a level above the top of the weir 44, glycol flows over the weir 44 and onto the next deck 30. This process is repeated until the glycol reaches the bottom 20 of the vessel 12 and is discharged through the glycol outlet 28. Thereafter, the “rich” glycol is treated to remove the water that was absorbed from the gas and then injected back into the contactor 10 to repeat the process.

Because glycol is continuously circulated through the dehydration system, it could be assumed that the loss of glycol could be kept to a minimum. However, glycol loss is a problem often encountered in gas dehydrator systems. One of the primary reasons for glycol loss is due to glycol being discharged from the vessel 12 through the gas outlet 24. This condition, commonly known as carry-over, is typically caused by momentary overloading of the vessel 12 as a result of pressure surges.

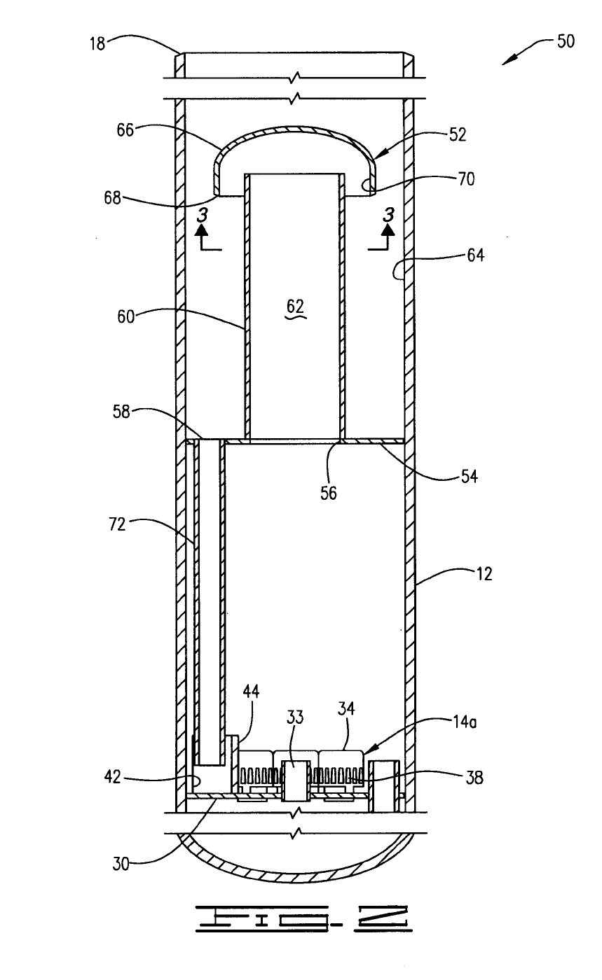

Referring now to FIG. 2, a counter flow contactor 50 constructed in accordance with the inventive concepts disclosed and claimed herein is shown. The contactor 50 is designed to overcome the problems of carry-over encountered with the prior art contactor 10 described above. The contactor 50 is similar in construction to the contactor 10 described above in reference to FIGS. 1 and 1A except that the contactor 50 is provided with a liquid carry-over reduction assembly 52. To this end, like numerals will be used to indicate like parts.

In one embodiment, the liquid carry-over reduction assembly 52 is positioned within the vessel 12 between the top most bubble tray assembly 14a and the upper end 18 of the vessel 12. More preferably, the liquid carry-over reduction assembly 52 is positioned between the uppermost bubble tray assembly 14 and the mist eliminator 16 (FIG. 1A). The liquid carry-over reduction assembly functions to deflect liquids, such as glycol, away from the gas outlet 24 and back to the top most bubble tray assembly 14a. The liquid carry-over reduction assembly 52 includes a horizontal deck or plate 54 provided with a central aperture 56 and a lateral aperture 58. A tubular member or chimney 60 extends upwardly from the plate 54 to define a passageway 62. The tubular member 60 further cooperates with the interior side of the vessel 12 to define an annular space 64.

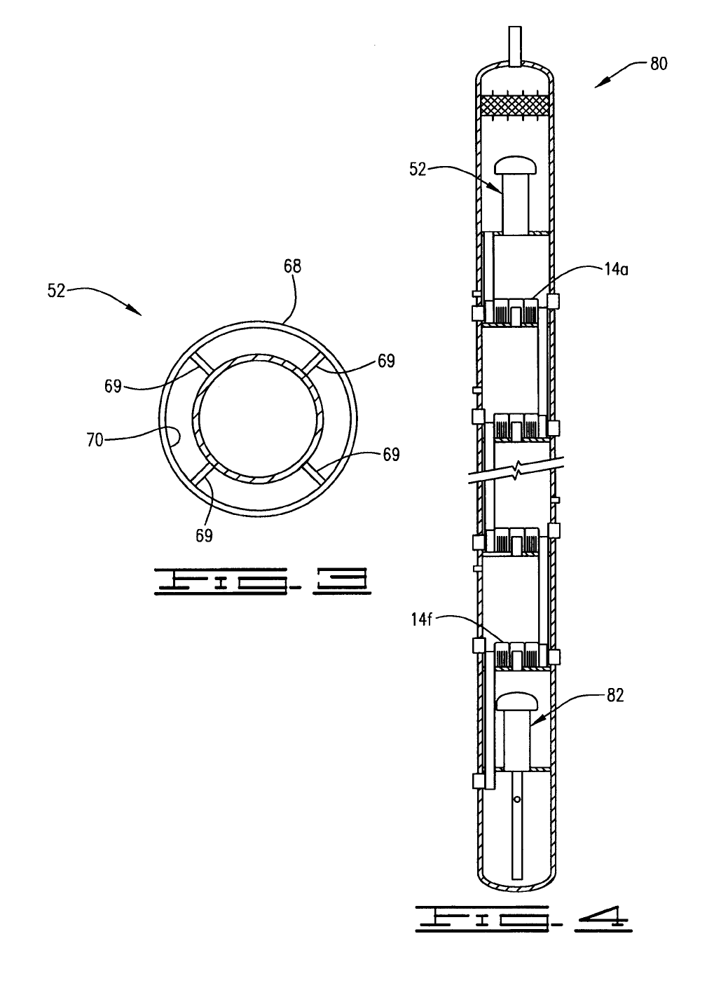

A deflector cap 66 is connected to an upper end of the tubular member 60 in such a way that a significant portion of the liquid carried up through the tubular member 60 will contact the underside of the deflector cap 66 and be deflected or redirected in an outward and downward direction and pass into the annular space 64. The liquid will also contact the deflector cap 66 so that a portion of the liquid may be deflected back down the tubular member 60 and onto the deck 30 of the uppermost bubble cap assembly 14a. In one embodiment, the deflector cap 66 is a hollow dome-shaped member having a lower annular edge 68 with a diameter greater than the diameter of the tubular member 60. The deflector cap 66 is connected to the tubular member 60 with a plurality of connector members 69 (FIG. 3) extending between the tubular member 60 and the deflector cap 66 in a spaced apart relationship to one another so as to define an annular passageway 70 between the tubular member 60 and the deflector cap 66.

The deflector cap 66 is preferably connected to the tubular member 60 so that the lower edge 68 of the deflector cap 66 is positioned below the upper end of the tubular member 60. As a consequence, as liquid and gas pass up through the tubular member 60, the deflector cap 66 will cause the travel path of the liquid and gas to be redirected in an outward and downward direction. Upon the liquid and gas passing beyond the lower edge 68 of the deflector cap 66, the gas will migrate toward the gas outlet 24 causing the gas to reverse its direction again in such a way that the liquid, which is heavier than the gas, to continue traveling in a downward direction through the annular space 64.

While the deflector cap 66 has been illustrated as being substantially dome-shaped, it should be appreciated that the deflector cap 66 may be formed to have a variety of shapes and configurations which function to produce the desired result of the liquid being returned to the uppermost bubble tray assembly 14. For example, in one embodiment, the deflector cap 66 may take the form of a flat circular plate.

The contactor 50 further includes a tubular downcomer 72 extending from the lateral aperture 58 to compartment 42 of the upper most bubble tray assembly 14a. The tubular downcomer 72 provides a pathway for the liquid to travel from the annular space 64 to the upper most bubble tray assembly 14a. The lower end of the downcomer 72 is positioned below the top of the weir 44 so as to form a liquid seal which prevents the migration of gas up through the downcomer 72.

It should be appreciated that while the liquid carry-over reduction assembly 52 is shown has being positioned above the uppermost bubble tray assembly 14a, the liquid carry-over reduction assembly 52 can be positioned in the vessel 12 so as to be associated with any of the bubble tray assemblies 14, or the contactor 50 may contain multiple liquid carry-over reduction assemblies 52.

For example, FIG. 4 illustrates another embodiment of a counter flow contactor 80 that includes one liquid carry-over reduction assembly 52 positioned above the upper most bubble tray assembly 14a and another liquid carry-over reduction assembly 82 positioned below the lowermost bubble tray 14f.

Also, the tubular downcomer 72 may extend to the next lowest bubble tray assembly 14, as shown, or the downcomer 72 may extend to any other bubble tray assembly 14, or extend below the lowermost bubble tray assembly 14. Likewise, the tubular downcomer 72 may extend within the vessel 12 or may run on the external side of the vessel 12. It should also be understood that the spacing and dimensions of the various components of the liquid carry-over reduction assembly 52 will vary as a function of variables such as gas composition, temperature, pressure, gas flow rate, and anticipated liquid carry-over volume. Also, an apparatus employing the inventive concepts disclosed herein may be used to extract components other than water from gas using liquid reagents other than glycol.

From the above description, it is clear that the inventive concepts disclosed and claimed herein are well adapted to carry out the objects and to attain the advantages mentioned herein as well as those inherent in the inventive concepts disclosed and claimed. While presently preferred embodiments of the inventive concepts have been described for purposes of this disclosure, it will be understood that numerous changes may be made which will readily suggest themselves to those skilled in the art and which are accomplished within the spirit of the inventive concepts disclosed and as defined in the appended claims.

What is claimed is:

1. A counter flow contactor, comprising:
a vessel having an upper end, a lower end, at least one gas inlet for receiving gas at the lower end, at least one gas outlet for discharging gas at the upper end, at least one desiccant inlet for receiving a desiccant fluid at the upper end, and at least one desiccant outlet for discharging the desiccant fluid at the lower end;
at least one bubble tray assembly positioned within the vessel between the upper end and the lower end, the bubble tray assembly comprising a deck having at least one aperture for allowing gas to pass upward past the deck, a tubular member extending upwardly from the aperture, a bubble cap positioned over the tubular member, and a liquid return line extending through the deck; and
a liquid carry-over reduction assembly positioned within the vessel, the liquid carry-over reduction assembly comprising:
a plate extending across the vessel, the plate having at least two apertures;
a tubular member extending upwardly from the plate in alignment with one of the apertures in such a way that the tubular member provides a fluid passage from a lower side of the plate to an upper side of the plate, the tubular member cooperating with the vessel to define a liquid receiving space;
a deflector plate spaced from the upper end of the tubular member in such a way that liquid passing up through the tubular member is deflected into the liquid receiving space while gas is allowed to pass to the gas outlet of the vessel; and
a liquid return line extending downwardly from the plate in alignment with the other aperture of the plate.

2. The contactor of claim 1, wherein the liquid carry-over reduction assembly is positioned in the vessel between an uppermost bubble tray assembly and the gas outlet of the vessel.

3. The contactor of claim 1, wherein the liquid return line of the liquid carry-over reduction assembly extends from the plate to the uppermost bubble tray assembly.

4. The contactor of claim 1 wherein the liquid receiving space is annular.

5. The contactor of claim 1, wherein the deflector plate is dome-shaped and has a diameter greater than the diameter of the tubular member.

6. The contactor of claim 5, wherein the deflector plate has a lower edge positioned below the upper end of the tubular member.

7. The contactor of claim 1, wherein the liquid carry-over reduction assembly is positioned between a lower most bubble tray assembly and the gas inlet.

8. The contactor of claim 1, wherein at least a portion of the return line of the liquid carry-over reduction assembly is positioned externally relative to the vessel.

9. The contactor of claim 8, wherein the tubular member is positioned concentrically in relation to the vessel.

10. The contactor of claim 1, further comprising a mist pad positioned between the deflector plate and the gas outlet.

11. The contactor of claim 1, wherein the liquid return line extends vertically from the liquid receiving space into the horizontal chamber such that a lower end of the liquid return line is sealed from the gas passing upwardly from the bubble tray assembly.

12. A counter flow contactor, comprising:
a vessel having an upper end, a lower end, at least one gas inlet for receiving gas at the lower end, at least one gas outlet for discharging gas at the upper end, at least one desiccant inlet for receiving a desiccant fluid at the upper end, and at least one desiccant outlet for discharging the desiccant fluid at the lower end;
a plurality of bubble tray assemblies positioned within the vessel between the upper end and the lower end, each bubble tray assembly comprising a deck having at least one aperture for allowing gas to pass upward past the deck, a tubular member extending upwardly from the aperture, a bubble cap positioned over the tubular member, and a liquid return line extending downwardly from the deck; and
at least one liquid carry-over reduction assembly positioned within the vessel, the liquid carry-over reduction assembly comprising:
a plate extending across the vessel, the plate having at least two apertures;
a tubular member extending upwardly from the plate in alignment with one of the apertures in such a way that the tubular member provides a fluid passage from a lower side of the plate to an upper side of the plate, the tubular member cooperating with the vessel to define a liquid receiving space;
a deflector plate spaced from the upper end of the tubular member in such a way that liquid passing up through the tubular member is deflected into the liquid receiving space while gas is allowed to pass to the gas outlet of the vessel; and
a liquid return line extending downwardly from the plate in alignment with the other aperture of the plate.

13. The contactor of claim 12, wherein the liquid carry-over reduction assembly is positioned in the vessel between an uppermost bubble tray assembly and the gas outlet of the vessel.

14. The contactor of claim 12, wherein the liquid return line of the liquid carry-over reduction assembly extends from the plate to the uppermost bubble tray assembly such that a lower end of the liquid return line is sealed from the gas passing upwardly from the bubble tray assembly.

15. The contactor of claim 12 wherein the liquid receiving space is annular.

16. The contactor of claim 12, wherein the deflector plate is dome-shaped and has a diameter greater than the diameter of the tubular member.

17. The contactor of claim 16, wherein the deflector plate has a lower edge positioned below the upper end of the tubular member.

18. The contactor of claim 13, wherein further comprising another liquid carry-over reduction assembly positioned between a lower most bubble tray assembly and the gas inlet.

19. The contactor of claim 12, wherein at least a portion of the liquid return line of the first liquid carry-over reduction assembly is positioned externally relative to the vessel.

20. The contactor of claim 12, wherein the tubular member is positioned concentrically in relation to the vessel.

21. The contactor of claim 12, further comprising a mist pad positioned between the deflector plate and the gas outlet.

22. The contactor of claim 12, wherein the liquid return line extends vertically from the liquid receiving space into the horizontal chamber such that a lower end of the liquid return line is sealed from the gas passing upwardly from the bubble tray assembly.
